(19) United States
(12) Patent Application Publication
(10) Pub. No.: US 2009/0153577 A1
(43) Pub. Date: Jun. 18, 2009

(54) METHOD AND SYSTEM FOR TEXTURING OF 3D MODEL IN 2D ENVIRONMENT

(75) Inventors: Sang Won GHYME, Daejeon (KR); Brian AHN, Daejeon (KR); Won Seok CHAE, Daejeon (KR); Byoung Tae CHOI, Daejeon (KR)

Correspondence Address: LOWE HAUPTMAN HAM & BERNER, LLP, 1700 DIAGONAL ROAD, SUITE 300, ALEXANDRIA, VA, 22314, US

(73) Assignee: Electronics and Telecommunications Research Institute, Daejeon (KR)

(21) Appl. No.: 12/048,495

(22) Filed: Mar. 14, 2008

(30) Foreign Application Priority Data
Dec. 15, 2007 (KR) 10-2007-0131821

(51) Int. Cl. G09G 5/00

(52) U.S. Cl. 345/582

(57) ABSTRACT

A method for texturing of 3D model in 2D environment includes (a) generating a texture map set for 3D model data; (b) UV unwrapping the 3D model data on each of projected planes to obtain a UV map set for each projected plane; (c) performing a 2D image authoring on the UV map set for each projected plane to produce an edited image; and (d) mapping the texture map set and the UV map set by reflecting the edited image to the texture map set and the UV map sets that are generated previously until a desired texture map set is completed.

### FIELD OF THE INVENTION

The present invention relates to a method and a system for texturing of 3D model in 2D environment; and, more particularly, to a method and a system for making a texture map that will be mapped on a 3D model in computer graphics modeling.

This work was supported by the IT R&D program of MIC/IITA [2007-S-051-01, Software Development for Digital Creature].

### BACKGROUND OF THE INVENTION

In computer graphics modeling, mapping is used to make the 3D model more realistic. Texture mapping is widely used among mapping methods for 3d model. Furthermore, among texture mapping methods, a method using bitmap image as texture map or mapping source is widely used.

When wrapping the surface of the model using the texture map, a process is necessary to determine the corresponding part of the surface where the texture map is wrapped. Such process is to set-up a coordinate system mapping the texture map to the surface of the model. By setting-up such a coordinate system for mapping, each point on the surface of the model can be mapped into a pixel on the texture map.

Typically, a 3D model is represented in the XYZ rectangular coordinate system, while a texture map is represented in the UVW orthogonal coordinate system which has named to be distinguished from XYZ rectangular coordinate system. The texture map is expressed as an image with a U axis in a horizontal direction and a V axis in a vertical direction, and has no depth information. Therefore, the texture map is briefly referred as a UV map.

The representative method of mapping between XYZ and UVW coordinate systems is to project a texture map onto a model as form of a plane, a cylinder or a sphere. A planar projection is to project an on-plane unwrapped image as it is onto the model in one direction. A cylindrical projection is to project an image by bending it into a cylindrical shape about the model. A spherical projection is to project an image by enclosing it into a spherical shape about the model.

These projections have advantages of simple structure and fast calculation; however, they have defects, as follows. The planar projection projects a bitmap image in one direction; and, therefore, the surface of the model which is parallel with the image is mapped well, while, the surface of the model which is perpendicular to the image has a problem of the occurrence of stripes. The cylindrical projection bends an image about an axis, and there occurs a lack of image continuity where an edge meets the opposite one. Like the cylindrical projection, the spherical projection has the same problem as described above.

Typically, the texture mapping using mapping methods is good to be applied in simple models, not complex models. For example, in a case of wrapping a person's face with a texture map, when an image of the person's face is made in advance before being projected to the face model, an exact mapping will not be performed between a face model and the image of the person's face since the image has been made without consideration of face geometry. However, it is not preferred to repeat fixing, projecting and confirming the image continuously until the face model and the image of the person's face are matched. In this case, the face of the model is unwrapped to the UV plane in conformity with the mapping coordinates instead of adjusting the image to the model. After that, a work is processed in a reversed way of extracting the UV plane in a form of an image to obtain a UV map, depicting, and then, mapping the texture map on the UV map. Accordingly, the process for wrapping a person's face with a texture map can be finished at once. Such method is called a UV unwrapping.

There is another method of mapping, that is, a method of depicting the texture map directly on a 3D model, like painting a sculpture with a brush, which is called 3D painting. This method is advantageous in that the work is done directly and by intuition. However, in comparison with depicting on a 2D image as if painting on a canvas, it is hard to perform fine work in any way, and thus, it is more preferred to employ the UV unwrap when the texture map has to be depicted very fine.

In various texture mapping processes, the UV unwrapping is preferred, however, the UV unwrapping has several problems. A first problem is that there is no easy way to perform the UV unwrapping, which will be discussed later. And second problem is that there occurs the loss of some information during UV unwrapping. Therefore, in the course of unwrapping the 3D faces on the 2D plane coercively, loss of two kinds of information must be endured. First, in order to make adjoining the 3D faces adjacent to each other even in 2D, the 3D faces have to be wrinkled, and during the course of wrinkling the 3D faces, each face is reduced or enlarged. Second, in the case of the model with closed surfaces without holes not the model with a hole like a pouch, it cannot be unwrapped completely in 2D, therefore, during the course of separating and unwrapping the model, some faces are no longer adjacent to each other and are fallen apart.

The first loss of information during the unwrapping makes each 3D face mapped with images in different resolutions, respectively. If the 3D faces are unwrapped on 2D in half the size, then the resolution will reduce to half the size when mapped. Further, if it is unwrapped in twice the size, then the resolution will enlarge to twice the size. There is no problem in the situation of enlarging the resolution; however, it is not desirable in the situation of reducing the resolution. Further, when there is a significant difference between changes of the resolution, the irregularity will be watched. Due to the second loss of information, when the faces that have been separated from each other in a 2D image are mapped on a 3D surface, there occur image discontinuities in edges adjacent to each other.

It is very hard to unwrap each 3D face on a 2D plane manually. The fully automated method is preferred, but there is no such method. However, there are simple UV unwrapping methods reversely using three kinds of projections introduced as methods for setting-up the mapping coordinate as set forth above. That are, methods of unwrapping each face of the 3D model on a plane of one direction, a cylindrical plane or a spherical plane. Typically, the surfaces of the 3D model are unwrapped on the 2D UV map by applying one of the three unwrapping methods to the entire 3D model or each section thereof. Then, the UV mapping coordinates of the faces that are not smooth are corrected (or re-designated) manually. All three unwrapping methods cannot be a perfect solution; therefore, manual unwrapping methods are heavily relied on and a lot of time is required for this process.

As described above, in the conventional arts, during the UV unwrapping for the texture mapping, there occurs a complicated process of re-designating UV coordinates and a problem that the UV mapped region to be UV mapped distorts.

### SUMMARY OF THE INVENTION

Therefore, the present invention provides a method and a system of directly making a texture map of a complicated 3D model only by authoring a 2D image.

In accordance with an aspect of the present invention, there is provided to a method for texturing of 3D model in 2D environment, including:

(a) generating a texture map set for 3D model data;

(b) UV unwrapping the 3D model data on each of projected planes to obtain a UV map set for each projected plane;

(c) performing a 2D image authoring on the UV map set for each projected plane to produce an edited image; and

(d) mapping the texture map set and the UV map set by reflecting the edited image to the texture map set and the UV map sets that are produced previously until a desired texture map set is completed.

In accordance with another aspect of the present invention, there is provided to a system for texturing of 3D model in 2D environment, comprising:

a texture map administration module for generating a texture map set for 3D model data;

a UV map administration module for UV unwrapping the 3D model data on each of projected planes to generate a UV map set for each projected plane;

an image authoring module for performing a 2D image authoring on the UV map set for each projected plane to produce an edited image; and

a UV mapping module for mapping the texture map set and the UV map set by reflecting the edited image to the texture map set and the UV map sets that are produced previously until a desired texture map set is completed, wherein the desired texture map set is added to the 3D model data.

The present invention can contribute in making a texture map of 3D model data efficiently. The conventional method wastes much more time in re-designating a UV mapping coordinate information than authoring an image for the texture map and accompanies a partial distortion of a texture image. However, the present invention is directed to a method that conceptually divides the texture map into some sections (each divided texture map is one UV map), which applies an automated UV unwrap method that reduces the required unnecessary time in re-designating the UV mapping coordinate information and, which forms a UV mapped region of a shape almost identical to each face of 3D model data to eliminate the partial distortion of the texture image.

### BRIEF DESCRIPTION OF THE DRAWINGS

The above and other objects and features of the present invention will become apparent from the following description of embodiments, given in conjunction with the accompanying drawings, in which:

FIG. 1 is a block diagram of a system for texturing 3D model in 2D environment in accordance with the present invention;

FIGS. 2A to 2D exemplarily illustrate 3D model data, a texture map for 3D model data and a UV map unwrapping 3D model data in various directions;

FIG. 3 shows a process correcting an image by refreshing the corresponding regions of unwrapped faces of texture map set and UV map set sharing regions of unwrapped faces on a UV map when the image is subjected to a 2D image authoring on the UV map; and

FIG. 4 is a flowchart for describing a texturing method of 3D model in 2D environment in accordance with the present invention.

### DETAILED DESCRIPTION OF THE EMBODIMENTS

Hereinafter, embodiments of the present invention will be described in detail with reference to the accompanying drawings.

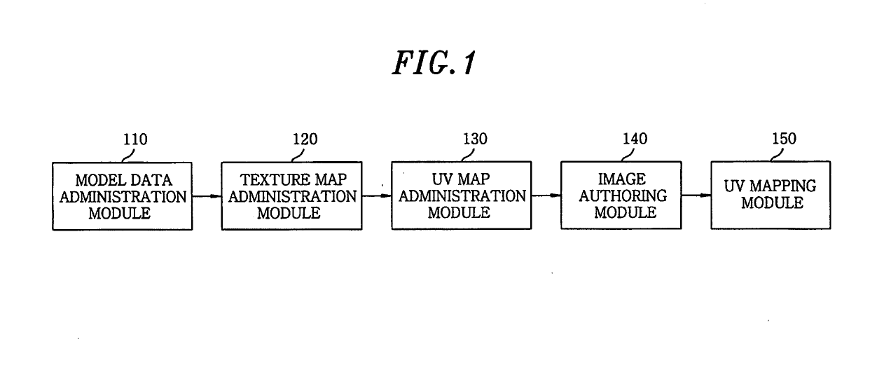

FIG. 1 is a block diagram showing a system for texturing 3D model in 2D environment in accordance with the present invention.

Referring to FIG. 1, the system for texturing 3D model in 2D environment includes an model data administration module 110, a texture map administration module 120, a UV map administration module 130, an image authoring module 140, and a UV mapping module 150.

The model data administration module 110 acquires 3D model data and stores the 3D model data to which a texture map set is added.

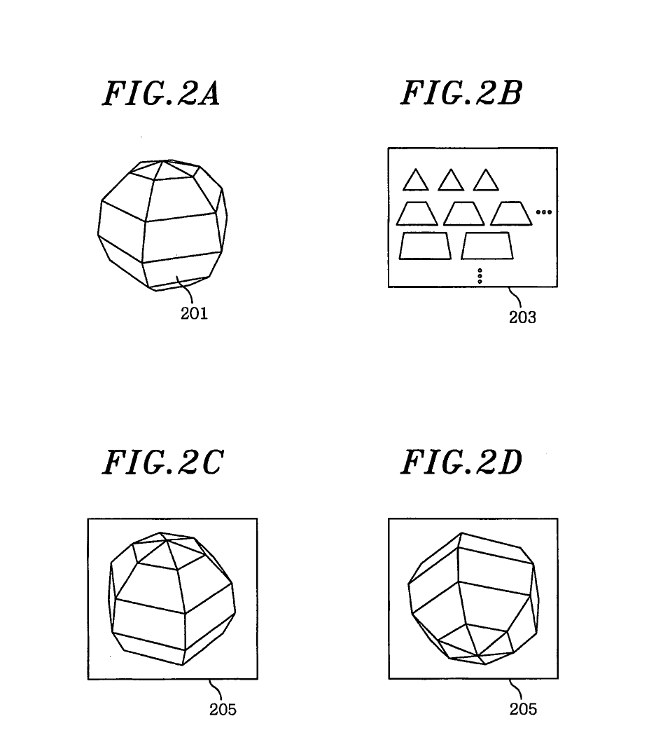

The texture map administration module 120 generates and manages a texture map set for the 3D model data. The texture map set includes a texture image and information on unwrapped faces wherein each unwrapped face is formed with UV mapping coordinates on the texture image. All faces on a 3D model are unwrapped into the UV plane on the text image in the individual positions thereof. Therefore, each unwrapped face has the same shape as a corresponding face on the 3D model. The texture image must be large enough for covering whole individual unwrapped faces. In addition, the texture map set has a large texture image and the unwrapped faces that are scattered on the texture image illustrated in FIG. 2.

The UV map administration module 130 generates and manages a UV map set. The UV map set includes a UV map image used for authorizing by a user and information on unwrapped faces wherein each unwrapped face is formed with UV mapping coordinates on the UV map image. During unwrapping the 3D model data on a mapping plane designated by a user, only faces facing the mapping plane are UV unwrapped and the other faces are not unwrapped. More specifically, among faces forming the 3D model data, faces having a normal vector forming an obtuse angle with a normal vector of the mapping plane are only UV unwrapped. This condition is intended for collecting unwrapped faces only which have similar-sized and less-deformed shapes to corresponding faces on the 3D model data. Through such a process, the texture map set has UV mapping coordinates for unwrapped faces corresponding to all faces on the 3D model, while the other UV map sets have UV mapping coordinates for unwrapped faces corresponding to some faces on the 3D model.

The image authoring module 140 performs a 2D image authoring on the UV map image included in the UV map set provided from the UV map administration module 130 to create an edited image. In this regard, the regions of unwrapped faces on the edited image are reflected to the texture map set and the UV map set which has the corresponding unwrapped faces in the UV mapping module 150. The generation of the UV map set in the UV map administration module 130 and the 2D image authoring performed by the image authoring module 140 are repeated until a desired texture map set is completed. As described above, the 3D model data is UV unwrapped in each direction to obtain the UV map set, the UV map image included in the UV map set is subject to the 2D image authoring, the edited image is applied to the texture map set, thereby finally acquiring the desired texture map set.

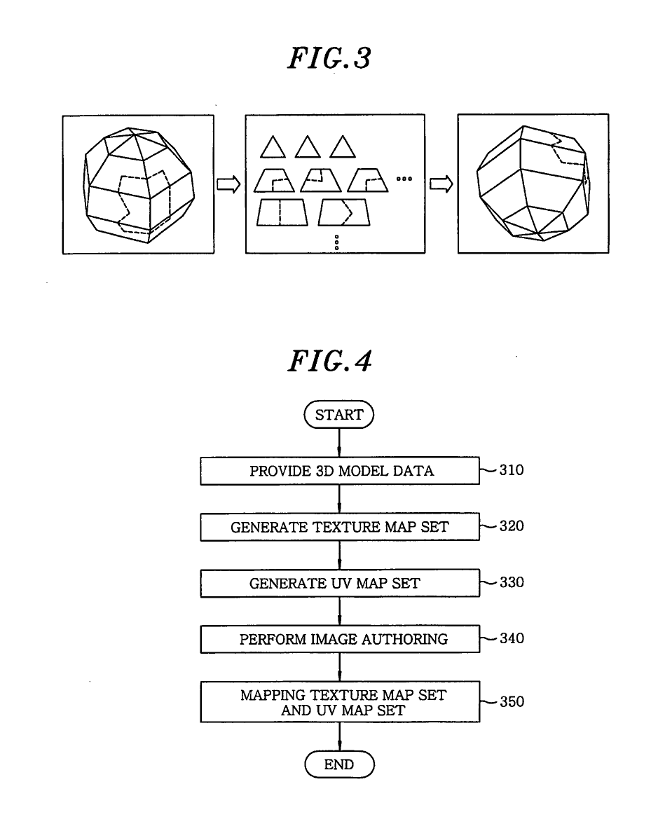

The UV mapping module 150 serves to connect the UV map set with the texture map set, so that the corresponding unwrapped faces between the texture map set and the UV map set have the same data. That is, when a UV map image in a designated UV map set is corrected in the image authoring module 140, the UV mapping module 150 also corrects image regions of unwrapped faces, which are included in a UV map set and are shared with the UV map set, in the texture map set and the UV map sets that are previously generated. This flow is depicted in FIG. 3.

Most regions of unwrapped faces having a shapes identical to corresponding faces in accordance with the condition required to perform the UV unwrapping as described above will not be adjacent to each other and will be scattered on the image. There is no possibility for the resolution of the image to get worse or distortion to occur since the unwrapped faces are shaped identical to the faces. However, it becomes impossible for a user to directly author an image on a texture map since there are almost no unwrapped faces adjacent to each other. On the contrary, the unwrapped faces included in the UV map set managed in the UV map administration module 130 are adjacent to each other; and, therefore are easy to author an image. Although a user directly works on the texture map set in order to acquire the final texture map set, the final map set can be achieved by way of UV unwrapping the 3D model data in several directions to obtain the UV map set, authoring the image included in the UV map set, and indirectly applying the edited image to the texture map set.

FIGS. 2A to 2D illustrate exemplary views depicting 3D model data 201, a texture map 203 for the 3D model data 201, and a UV map 205 UV unwrapping the 3D model data 201 in several directions.

The polygonal shapes in the texture map 203 and the UV map 205 indicate unwrapped faces expressed using the UV mapping coordinates included in the texture map set and the UV map set. The texture map set and the UV map set have only one texture image commonly, but may further have another reference image with the notification on the unwrapped faces in order to refer to in authoring the image by the user. This reference image is made internally and is limited for the use of reference only.

FIG. 4 is a flowchart describing a texturing method of 3D model in 2D environment in accordance with the present invention.

In respect with FIG. 4, the texturing method of the present invention includes the steps of providing 3D model data (step 310); generating a texture map set for 3D model data (step 320); generating a UV map set that is obtained by UV unwrapping the 3D model data on a designated plane among planes of various directions (step 330); performing 2D image authoring on the UV map set to produce an edited image (step 340); mapping the texture map set and the UV map set by reflecting the edited image to the texture map set and the UV map set until a desired texture map set is completed while repeating the steps 330 and 340, thereby obtaining the 3D model data added with the desired texture map set (step 350).

First, in the step 310, the 3D model data is provided to the texture map administration module 120.

Then, in the step 320, a texture map set for the 3D model data is generated in the texture map administration module 120.

In the step 330, the 3D model data is unwrapped in a specific direction to generate a UV map set.

In the step 340, a UV map image in the UV map set is subjected to a 2D image authoring to produce an edited image.

In the step 350, the content of the edited image is reflected to the texture map set and the UV map sets that are generated previously so that the texture map set and the UV map set are mapped. The step 350 is continued by repeating the steps 330 and 340 until a desired texture map set is completed, that is, all regions of unwrapped faces on the texture image are filled with the texture data.

Each time performing the repetition, the 3D model date is UV unwrapped in other projected plane in sequence to produce the UV map set newly in the step 330, and the UV map sets generated previously are corrected at each repetition in the step 340.

Finally, if the desired texture map set is completed, the desired texture map set obtained finally is added to the 3D model data and then stored in the model data administration module 110.

On the other hand, the present invention can be realized as an independent software application or a plug-in of an existing image authoring tool.

While the invention has been shown and described with respect to the embodiments, it will be understood by those skilled in the art that various changes and modification may be made without departing from the scope of the invention as defined in the following claims.

What is claimed is:

1. A method for texturing of 3D model in 2D environment, comprising:
(a) generating a texture map set for 3D model data;
(b) UV unwrapping the 3D model data on each of projected planes to obtain a UV map set for each projected plane;
(c) performing a 2D image authoring on the UV map set for each projected plane to produce an edited image; and
(d) mapping the texture map set and the UV map set by reflecting the edited image to the texture map set and the UV map sets that are generated previously until a desired texture map set is completed.

2. The method of claim 1, wherein the texture map set includes a texture image and information on unwrapped faces, each unwrapped face being formed with UV mapping coordinates on the texture image.

3. The method of claim 2, wherein the UV map set includes a UV map image for authoring and information on unwrapped faces, each unwrapped face being formed with UV mapping coordinates on the UV map image and being corresponded to some faces that the 3D model data is unwrapped on the projected plane.

4. The method of claim 3, wherein the edited image is reflected to the texture image having unwrapped faces that are shared between the texture map set and the UV map set, and the UV map image corresponding to the shared unwrapped faces in the UV map sets that are previously generated.

5. The method of claim 2, wherein the desired texture map set is completed by filling the regions of unwrapped faces in the texture image with the edited image.

6. A system for texturing of 3D model in 2D environment, comprising:
a texture map administration module for generating a texture map set for 3D model data;
a UV map administration module for UV unwrapping the 3D model data on each of projected planes to generate a UV map set for each projected plane;
an image authoring module for performing a 2D image authoring on the UV map set for each projected plane to produce an edited image; and
a UV mapping module for mapping the texture map set and the UV map set by reflecting the edited image to the texture map set and the UV map sets that are produced previously until a desired texture map set is completed, wherein the desired texture map set is added to the 3D model data.

7. The system of claim 6, wherein each of the texture maps includes a texture image and information on unwrapped faces, each unwrapped face being formed with UV mapping coordinates on the texture image.

8. The system of claim 6, wherein each of the UV maps includes a UV map image for user authorizing and information on unwrapped faces, each unwrapped face being formed with UV mapping coordinates on the UV map image and being corresponded to some faces that the 3D model data is unwrapped on the projected plane.

9. The system of claim 6, wherein the edited image is reflected to a region shared between the texture map set and the UV map sets that are previously produced within the regions of the edited image.

10. The system of claim 9, wherein the shared region is obtained when an unwrapped face corresponding to a face on 3D model exists in the texture map set and the UV map sets that are previously produced.
